(19) United States
(12) Patent Application Publication
(10) Pub. No.: US 2010/0082515 A1
(43) Pub. Date: Apr. 1, 2010

(54) ENVIRONMENTAL FACTOR BASED VIRTUAL COMMUNICATION SYSTEMS AND METHODS

(75) Inventors: Don Relyea, Dallas, TX (US); Shadman Zafar, Plano, TX (US); Brian Roberts, Frisco, TX (US); Ryan Trees, Farmers Branch, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES, LLC, Temple Terrace, FL (US)

(21) Appl. No.: 12/238,866

(22) Filed: Sep. 26, 2008

(51) Int. Cl. G06N 5/02

(52) U.S. Cl. 706/47

(57) ABSTRACT

In an exemplary method, an agent facility associated with an access device and a user is maintained, data representative of one or more rules associated with the user is also maintained, at least one environmental factor of the user is detected, and a predefined action is performed with the agent facility in response to the detected environmental factor and in accordance with at least one of the rules. In another exemplary method, a virtual entity configured to electronically represent one or more traits is maintained, electronic interaction by the virtual entity with at least one user is facilitated, at least one environmental factor of the user is detected; and at least one parameter defining the virtual entity is adjusted in accordance with the at least one detected environmental factor.

### BACKGROUND INFORMATION

Advances in electronic communications technologies have interconnected people and allowed for distribution of information perhaps better than ever before. To illustrate, social networking applications, which allow people to virtually connect with one another, have become enormously popular.

One downfall associated with current social networking applications is that the users thereof must be engaged with their computers in order to participate. This inhibits the ability of users to utilize social networking applications in many real-world settings where they may not have direct access to their computers.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary social networking system according to principles described herein.

FIG. 2 shows an exemplary implementation of the system of FIG. 1 according to principles described herein.

FIG. 3 shows another exemplary implementation of the system of FIG. 1 according to principles described herein.

FIG. 4 illustrates components of an exemplary social network subsystem according to principles described herein.

FIG. 5 illustrates components of an exemplary access subsystem according to principles described herein.

FIG. 6 shows a configuration wherein a plurality of access devices are physically located at different geographic locations within an exemplary network footprint according to principles described herein.

FIG. 7 illustrates an exemplary data structure configured to define a virtual entity according to principles described herein.

FIG. 8 shows a graphical object configured to represent a virtual entity according to principles described herein.

FIG. 9 shows a graphical object configured to represent a virtual entity that has evolved from the virtual entity represented by the graphical object shown in FIG. 8 according to principles described herein.

FIG. 10 illustrates an exemplary method of utilizing a agent facility to perform one or more actions according to principles described herein.

FIG. 11 illustrates an exemplary method of utilizing a virtual entity to interact with at least one user according to principles described herein.

### DETAILED DESCRIPTION OF PREFERRED EMBODIMENTS

Environmental factor-based virtual communication systems and methods are described herein.

In some examples, an access subsystem associated with a user may be selectively and communicatively coupled to a social network subsystem over a network. The access subsystem may include a detecting facility configured to detect at least one environmental factor of a user, a storage facility configured to maintain data representative of one or more rules, and an agent facility configured to perform a predefined action in response to the detected environmental factor and in accordance with at least one of the rules. The at least one detected environmental factor may include, but is not limited to, a geographic environmental factor, a virtual environmental factor, an electronic environmental factor, and/or a sensory environmental factor. Examples of such environmental factors will be given below.

The access subsystem may additionally or alternatively include a virtual entity facility configured to generate a virtual entity defined by one or more parameters and configured to electronically represent one or more traits. The traits represented by the virtual entity may include any personality trait, habit, tendency, action, like, dislike, preference, and/or other factor associated with a user 230 of the access subsystem. A processing facility may be configured to facilitate electronic interaction by the virtual entity with the user and/or with one or more other users. The virtual entity facility is further configured to adjust at least one of the parameters in accordance with the at least one detected environmental factor. The parameter adjustment is configured to adjust a manner in which the virtual entity electronically interacts with one or more of the users.

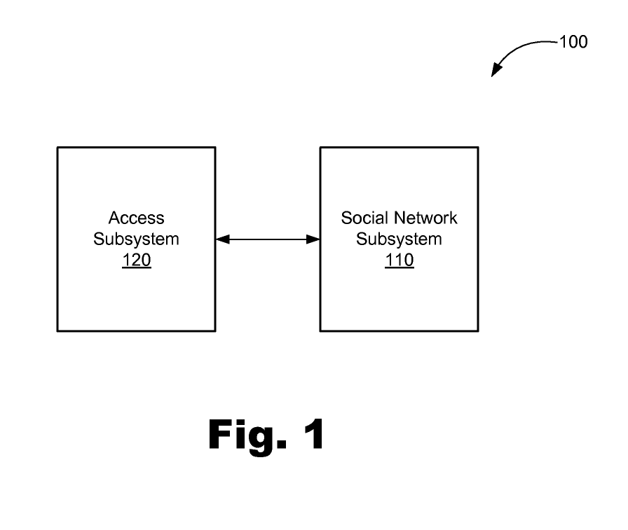

FIG. 1 illustrates an exemplary social networking system 100 (or simply “system 100”). As shown in FIG. 1, system 100 may include a social network subsystem 110 and an access subsystem 120 configured to communicate with one another.

Access subsystem 120 and social network subsystem 110 may communicate using any communication platforms and technologies suitable for transporting data representative of content, content metadata, content management commands, and/or other communications, including known communication technologies, devices, media, and protocols supportive of remote or local data communications. Example of such communication technologies, devices, media, and protocols include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), Evolution Data Optimized Protocol (“EVDO”), radio frequency (“RF”) signaling technologies, signaling system seven (“SS7”) technologies, Ethernet, in-band and out-of-band signaling technologies, and other suitable communications networks and technologies.

In some examples, system 100 may include any computer hardware and/or instructions (e.g., software programs), or combinations of software and hardware, configured to perform the processes described herein. In particular, it should be understood that components of system 100 may be implemented on one physical computing device or may be implemented on more than one physical computing device. Accordingly, system 100 may include any one of a number of computing devices, and may employ any of a number of computer operating systems.

Accordingly, the processes described herein may be implemented at least in part as computer-executable instructions, i.e., instructions executable by one or more computing devices, tangibly embodied in a computer-readable medium. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

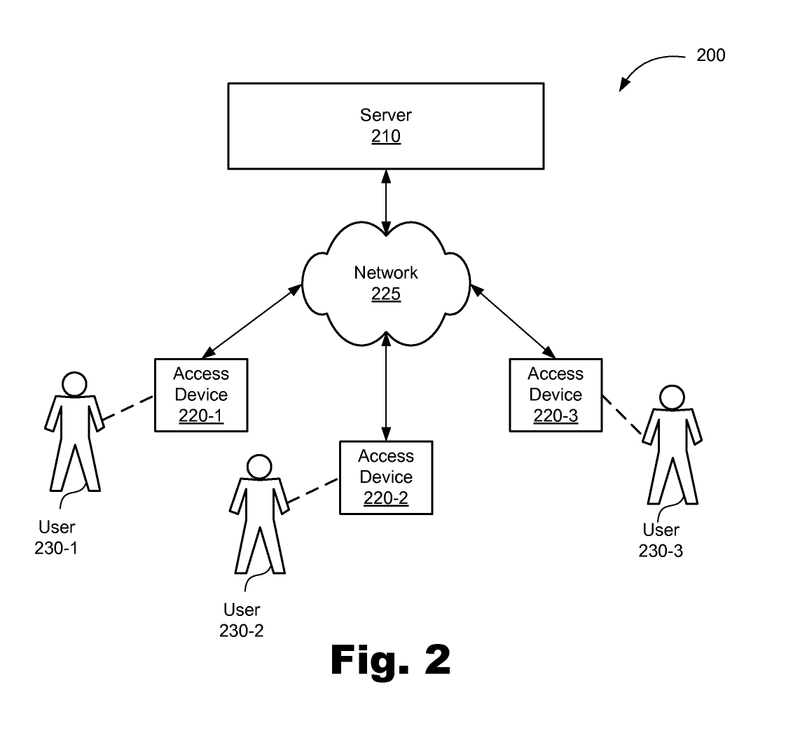

FIG. 2 shows an exemplary implementation 200 of system 100. In implementation 200, social network subsystem 110 may include or be implemented within at least one server 210, and access subsystem 120 may include or be implemented within at least one access device (e.g., access devices 220-1 through 220-3, collectively referred to herein as “access devices 220”) configured to communicate with server 210 by way of a network 225. Network 225 may include one or more networks, including, but not limited to, wireless networks, mobile telephone networks (e.g., cellular telephone networks), closed media networks, subscriber television networks, cable networks, satellite networks, the Internet, intranets, local area networks, public networks, private networks, optical fiber networks, broadband networks, narrowband networks, voice communications networks, Voice over Internet Protocol “(VoIP”) networks, Public Switched Telephone Networks (“PSTN”), and any other networks capable of carrying data representative of content, data associated with content (e.g., metadata), data management commands, and/or communications signals between access devices 220 and server 210. Communications between server 210 and access devices 220 may be transported using any one of above-listed networks, or any combination or sub-combination of the above-listed networks.

Each access device 220 may include any device configured to perform one or more of the processes described herein, including communicating with and/or transmitting and receiving content, data associated with content (e.g., metadata), social networking commands, and/or content operation commands to/from social network subsystem 110 by way of network 225. Access device 120 may include, but is not limited to, a computing device (e.g., a desktop or laptop computer), a set-top box, a communication device, a wireless computing device, a wireless communication device (e.g., a mobile phone), a personal digital assistant, a content recording device (e.g., a camera, audio recorder, video camera), a vehicular computing and/or communication device, a content-enabled device, a gaming device, and/or any other device configured to acquire, transmit, receive, access, or otherwise process content.

As shown in FIG. 2, each access device 220 may be associated with at least one user (e.g., users 230-1 through 230-3, collectively referred to herein as “users 230”). As will be described in more detail below, each user 230 may virtually connect or otherwise interact with other users 230 using social networking subsystem 110. Moreover, each user 230 may provide and/or access content stored within social network subsystem 110 via one or more of the access devices 220.

In some examples, one or more of the users 230 may be subscribers to or users of one or more services provided over network 225. For example, one or more of the users 230 may be subscribers to a particular social networking service and/or a wireless telephone service. Other services may be provided over network 225 as may serve a particular application.

Social network subsystem 110 may be configured to support communication with access subsystem 120 via multiple network platforms. For example, user 230 may utilize multiple access devices 220, each a part of a different network platform, to interact with social network subsystem 110.

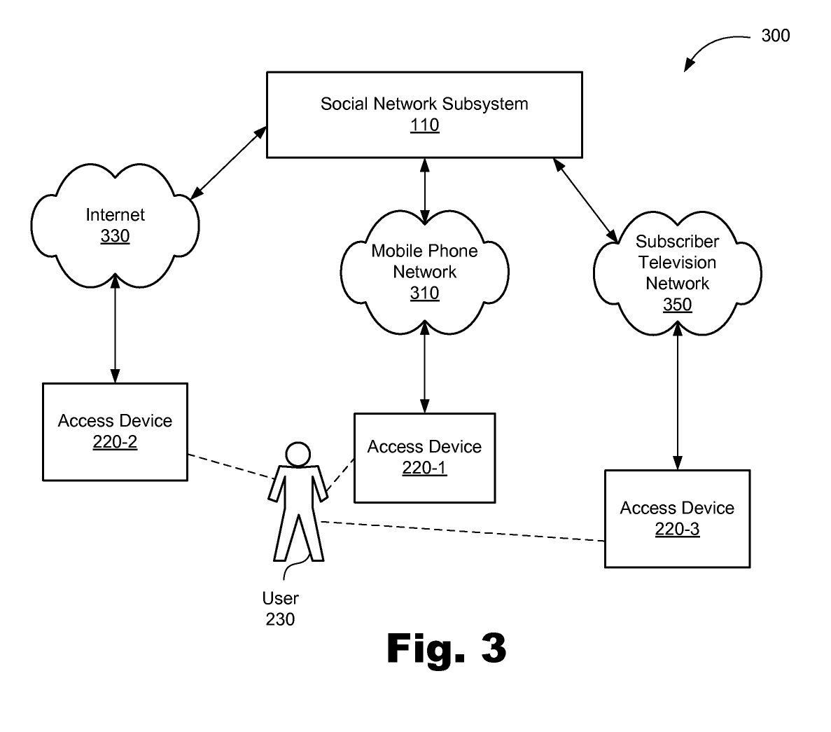

To illustrate, FIG. 3 shows an exemplary implementation 300 of system 100. As shown in FIG. 3, the implementation 300 may include social network subsystem 110 and access devices 220-1 through 220-3 associated with user 230. Social network subsystem 110 may be configured to communicate with each access device 220 over a different network platform. For example, social network subsystem 110 may be configured to communicate with access device 220-1 (e.g., a mobile phone) over a mobile phone network 310, with access device 220-2 (e.g., a personal computer) over the Internet 330, and/or with access device 220-3 (e.g., a set-top box) over subscriber television network 350. Hence, user 230 may be able to utilize any of the access devices 220-1 through 220-3 to provide and/or access content stored within social network subsystem 110. It will be recognized that mobile phone network 310, the Internet 330, and subscriber television network 350 may be part of network 225 shown in FIG. 2. It will also be recognized that the networks shown in FIG. 3 are merely illustrative of the many different types of networks that may facilitate communication between social network subsystem 110 and access subsystem 120.

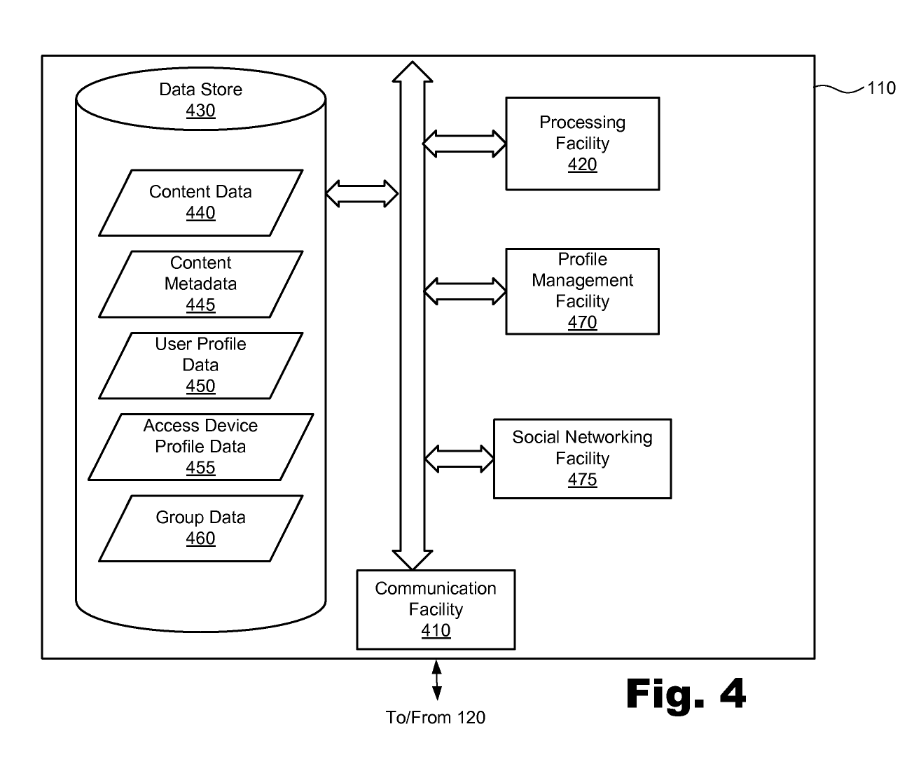

FIG. 4 illustrates components of an exemplary social network subsystem 110. The components of social network subsystem 110 may include or be implemented as hardware, computing instructions (e.g., software) embodied on a computer-readable medium, or a combination thereof. In certain embodiments, for example, one or more components of social network subsystem 110 may include or be implemented on one or more servers, such as server 210, configured to communicate over network 225. While an exemplary social network subsystem 110 is shown in FIG. 4, the exemplary components illustrated in FIG. 4 are not intended to be limiting. Indeed, additional or alternative components and/or implementations may be used.

As shown in FIG. 4, social network subsystem 110 may include a communication facility 410, which may be configured to communicate with access subsystem 120, including receiving data representative of content, data representative of social networking commands, and content data operations from access subsystem 120 and/or any other device or subsystem. Communication facility 410 may additionally or alternatively be configured to transmit content, social networking commands, and/or any other data to access subsystem 120 and/or any other device or subsystem by way of network 225. The communication facility 410 may include and/or support any suitable communication platforms and technologies for communicating with and transporting content and associated data to/from access subsystem 120. Communication facility 410 may be configured to support a variety of communication platforms, protocols, and formats such that social network subsystem 110 can receive data from and distribute data to a variety of computing platforms (e.g., a mobile telephone service platform, a web-based platform, a subscriber television platform, etc.) using a variety of communications technologies. Accordingly, the social network subsystem 110 may be configured to support a multi-platform system in which data can be received from and provided to diverse platforms.

Social network subsystem 110 may include a processing facility 420 configured to control operations of components of the social network subsystem 110. Processing facility 420 may execute or direct execution of operations in accordance with computer-executable instructions stored to a computer-readable medium such as a data store 430. As an example, processing facility 420 may be configured to process data and/or communications received from or to be transmitted to access subsystem 120.

In some examples, processing facility 420 may be configured to perform device-specific content formatting before content is provided to (e.g., downloaded by) a particular access device 220. In this manner, the content may be optimally viewed or otherwise experienced by a user of the access device 220.

Data store 430 may include one or more data storage media, devices, or configurations and may employ any type, form, and combination of storage media. For example, the data store 430 may include, but is not limited to, a hard drive, network drive, flash drive, magnetic disc, optical disc, random access memory (“RAM”), dynamic RAM (“DRAM”), other non-volatile and/or volatile storage unit, or a combination or sub-combination thereof. Data store 430 may store any suitable type or form of electronic data, including content data 440, content metadata 445, user profile data 450, access device profile data 455, and/or group data 460.

Content data 440 may include or be stored within one or more content instances. As used herein, the term “content instance” refers generally to any data record or object (e.g., an electronic file) storing or otherwise associated with content, which may include electronic data representative of text, one or more messages (e.g., short message service (“SMS”) messages, electronic mail messages, or multimedia message service (“MMS”) messages), one or more symbols, one or more graphics, one or more images (e.g., digital photographs and video frames), email contacts, video, audio, multimedia, video games, or any segment, component, or combination of these or other forms of electronic data that may be viewed or otherwise experienced by a user. Content metadata 445 may include metadata associated with one or more of the content instances.

User profile data 450 may include any information descriptive of one or more users who are associated with social network subsystem 110 and/or otherwise receive services provided over network 225. User profile data 450 may include user authentication information, user identifiers, information about one or more access devices 120 that correspond with a user, user preferences, and/or any other information related to one or more users.

Access device profile data 455 may include any information descriptive of access subsystem 120 and/or any access device 220 configured to communicate with social network subsystem 110. For example, access device profile data 455 may include data representative of one or more access device identifiers, network addresses (e.g., internet protocol (“IP”) addresses), network resources, computing resources, subscription information, device permissions, platforms, etc.

Group data 460 may include any information that can be used to identify groupings of users 230 and/or access devices 220. For example, group data 460 may include information indicating that certain users 230 are members of a group within a particular social network. Accordingly, group data 460 may be useful for facilitating selective access of content data 440 by users 230 within a group. In certain embodiments, group data 460 may include information that can be used to access user profile data 450 corresponding to users in a group, and the user profile data 450 may include information that can be used to identify user associations with access devices 120.

Group data 460 may be defined in any suitable manner, including users (e.g., a member of a particular social network) defining groups and providing data representative of the defined groups to social network subsystem 110. For example, a user may specify one or more social network connections and provide the social network connections to social network subsystem 110 in the form of group data 460. In certain embodiments, at least certain groups are defined based on user subscription accounts for services provided over network 225. For example, a default group may be defined by social network subsystem 110 to include any users associated with a subscription account (e.g., a social networking account).

In certain embodiments, data 440-460 may be stored using one or more suitable data entities and/or structures, including one or more relational or hierarchical data tables, for example.

Social network subsystem 110 may include a profile management facility 470, which may be configured to manage one or more user profiles and/or access device profiles and/or maintain a database of permissions associated therewith. For example, profile management facility 470 may be configured to facilitate updating of a user profile and/or an access device profile by a user. Additionally or alternatively, profile management facility 470 may be configured to process a user profile and/or an access device profile in the context of a user requesting access to content stored within data store 430 and determine, based on the user profile and/or access device profile, whether the user should be granted access to the content.

Social network subsystem 110 may further include a social networking facility 475, which may be configured to facilitate one or more social networking functions. Exemplary social networking functions may include, but are not limited to, providing interfaces wherein users may virtually interact with each other, making content accessible to different users within a particular social network, providing content recommendations to one or more users, maintaining one or more databases of user permissions and/or privileges, and/or any other action associated with social networking.

Social networking facility 475 may include or be implemented as hardware, computing instructions (e.g., software) tangibly embodied on a computer-readable medium, or a combination of hardware and computing instructions configured to perform one or more of the processes described herein. In certain embodiments, social networking facility 475 may be implemented as a software application embodied on a computer-readable medium such as data store 430 and configured to direct the processing facility 420 to execute one or more of the processes described herein.

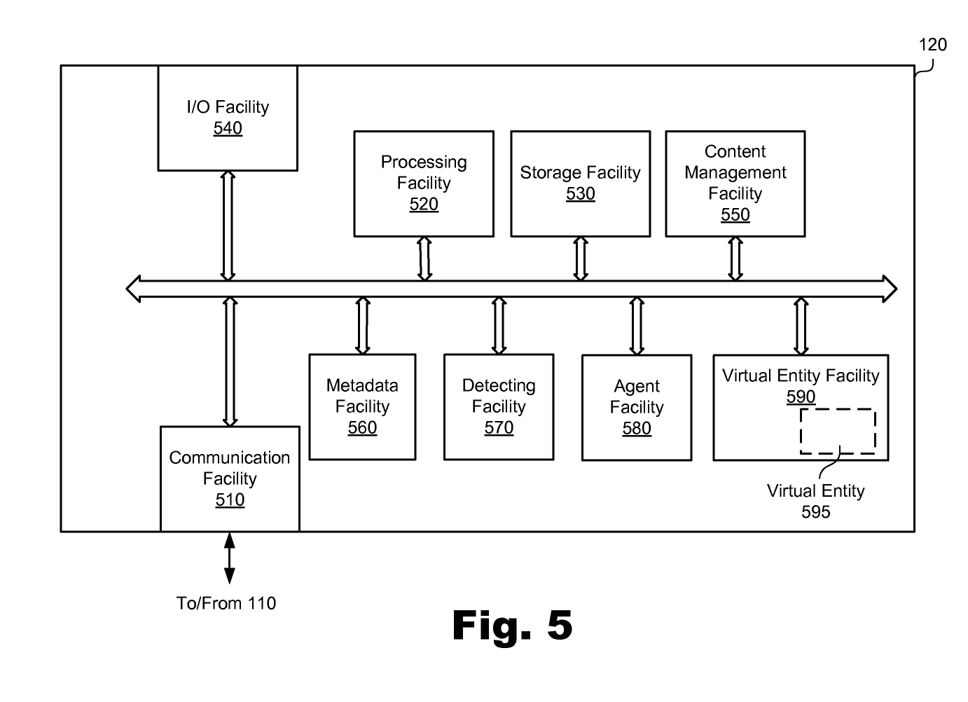

FIG. 5 illustrates components of an exemplary access subsystem 120. As shown in FIG. 5, access subsystem 120 may include a communication facility 510, processing facility 520, storage facility 530, input/output (“I/O”) facility 540, content management facility 550, metadata facility 560, detecting facility 570, agent facility 580, and virtual entity facility 590 communicatively connected to one another. The facilities 510-590 may be communicatively connected using any suitable technologies. Each of the facilities 510-590 may be implemented as hardware, computing instructions (e.g., software) tangibly embodied on a computer-readable medium, or a combination of hardware and computing instructions configured to perform one or more of the processes described herein. In certain embodiments, for example, agent facility 580, virtual entity facility 590, and/or one or more other facilities may be implemented as one or more software applications embodied on a computer-readable medium such as storage facility 530 and configured to direct processing facility 520 of the access subsystem 120 to execute one or more of the processes described herein.

Communication facility 510 may be configured to communicate with social network subsystem 110 (e.g., over network 225), including sending and receiving data representative of content, data associated with content, content management commands, social networking commands, and/or other communications to/from social network subsystem 110. Communication facility 510 may include any device, logic, and/or other technologies suitable for transmitting and receiving such data. In certain embodiments, communication facility 510 may be configured to support other network service communications over network 225, including wireless voice, data, and messaging service communications, for example. Communication facility 510 may be configured to interface with any suitable communication media, protocols, formats, platforms, and networks, including any of those mentioned herein.

Processing facility 520 may be configured to execute and/or direct execution of operations of one or more components of the access subsystem 120. Processing facility 520 may direct execution of operations in accordance with computer-executable instructions such as may be stored in storage facility 530 or another computer-readable medium.

Storage facility 530 may include one or more data storage media, devices, or configurations and may employ any type, form, and combination of storage media. For example, the storage facility 530 may include, but is not limited to, a hard drive, network drive, flash drive, magnetic disc, optical disc, random access memory (“RAM”), dynamic RAM (“DRAM”), other non-volatile and/or volatile storage unit, or a combination or sub-combination thereof. Data may be temporarily and/or permanently stored in the storage facility 530.

Different types of data may be stored within storage facility 530 as may serve a particular application. For example, rules data representative of one or more rules defined by a user, access subsystem 120, and/or social network subsystem 110 may be maintained within storage facility 530. In some examples, as will be described in more detail below, agent facility 580 and/or virtual entity facility 590 may be configured to perform one or more predefined actions in accordance with at least one of the rules. Additionally or alternatively, data defining a virtual entity generated by virtual entity facility 590 may be stored within storage facility 530. It will be recognized that data stored within storage facility 530 may additionally or alternatively be stored within data store 430 and/or within any other storage medium as may serve a particular application.

I/O facility 540 may be configured to receive user input and provide user output and may include any hardware, firmware, software, or combination thereof supportive of input and output capabilities. For example, I/O facility 540 may include one or more devices for capturing or otherwise creating content, including, but not limited to, a still-shot camera, video camera, scanner, microphone, keyboard or keypad, touch screen component, and/or receiver (e.g., an RF or infrared receiver). Accordingly, a user 230 of access subsystem 120 may create or otherwise acquire content (e.g., by taking a picture, creating a word processing document, or downloading a data file). In some examples, the acquired content may be provided to social network subsystem 110.

In some examples, I/O facility 540 may be configured to work in conjunction with detecting facility 570 to detect one or more factors indicative of an environment of a user 230. These factors will be described in more detail below.

I/O facility 540 may additionally or alternatively include one or more devices for presenting content for experiencing by the user 230, including, but not limited to, a graphics engine, a display, one or more display drivers, one or more audio speakers, and one or more audio drivers. Accordingly, I/O facility 540 may present content (e.g., play back and/or display) for experiencing by the user 230. I/O facility 540 may also be configured to provide other output for the user 230, such as graphical user interfaces.

Content management facility 550 may be configured to provide one or more tools for management of content. The tools may include or be provided using hardware, computer-readable instructions embodied on a computer-readable medium such as storage facility 530, or a combination of hardware and computer-readable instructions. In certain embodiments, content management facility 550 may be implemented as a software application embodied on a computer-readable medium such as storage facility 530 and configured to direct the processing facility 520 of the access subsystem 120 to execute one or more of the content management operations described herein.

The tools may be configured to enable user 230 to create, format, modify, delete, annotate (e.g., edit, rate, label, add a note to, comment about, and categorize content), access, retrieve, copy, move, send, request, receive, decrypt, and/or otherwise manage content stored within access subsystem 120 and/or social network subsystem 110. For example, a user 230 utilizing the content management tools may create and provide a content instance to social network subsystem 110. Through content management facility 550, the user 230 may access and manage the content instance. Content management facility 550 may generate and provide content management commands to social network subsystem 110, which may be configured to receive and process the commands, and to identify and perform appropriate content management operations based on the commands.

In some examples, the one or more tools provided by content management facility 550 may include one or more application clients configured to facilitate access to content stored within or received from social network subsystem 110. Exemplary application clients may include, but are not limited to, Internet browsers, image viewers, media players, and/or document readers and editors.

Metadata facility 560 may be configured to perform operations associated with content metadata, including generating, updating, and providing content metadata. The term “metadata” as used herein refers generally to any electronic data descriptive of content and/or content instances. For example, metadata may include, but is not limited to, content instance identifiers (e.g., file names), time data, location data, user data, source data, destination data, size data, creation data, modification data, data structure data, and access data descriptive of content and/or one or more content instances. Examples of metadata may include time data associated with a data operation (e.g., creating, modifying, deleting, receiving, or sending content), location data associated with a data operation (e.g., a geographic or network location at which content is created), user data identifying one or more users associated with content (e.g., a user who created, modified, deleted, sent, received, accessed, or otherwise operated on or is owner of content), content type information (e.g., file type or other predefined category of content), content transport information, source data associated with a source of content (e.g., a user from whom content is received), and destination data associated with a destination to which content is sent (e.g., a user to whom content is transmitted).

Metadata facility 560 may include hardware, computer-readable instructions embodied on a computer-readable medium such as storage facility 530 (e.g., one or more content management software applications), or a combination of hardware and computer-readable instructions. In certain embodiments, metadata facility 560 may be implemented as a software application embodied on a computer-readable medium such as storage facility 530 and configured to direct the processing facility 520 of the access subsystem 120 to execute one or more of metadata operations described herein.

Metadata facility 560 may be configured to detect content management operations and to generate, update, delete, and/or provide metadata associated with the operations. For example, if a content instance is transmitted to a destination, such as by transmitting data representative of the content instance over network 225, metadata facility 560 may detect the transmission of the content instance and generate and provide metadata indicating a time at which the content instance is sent and the destination to which the content instance is sent (e.g., a user or remote device identifier). Similarly, if another content instance is received by access subsystem 120 from a source (e.g., social network subsystem 110), metadata facility 560 may detect the receipt of the other content instance and generate and provide metadata indicating a time at which the other content instance is received and the source that provided the other content instance.

Detecting facility 570 may be configured to detect one or more factors indicative of an environment of a user. Such factors will be referred to herein as “environmental factors” and may include anything related to a geographic, sensory, virtual, and/or electronic environment of a user. As will be described in more detail below, the agent facility 580 and/or the virtual entity facility 590 may be configured to perform one or more actions in response to the detected environmental factors.

In some examples, an environmental factor may include a geographic location of a user 230. To this end, detecting facility 570 may be configured to utilize one or more location detection technologies to determine a geographic location of the user 230. Exemplary location detection technologies that may be utilized by detecting facility 570 include global positioning system (“GPS”) technologies and trilateration.

Another exemplary environmental factor may include sensory input as experienced by a user 230. For example, an environmental factor may include data representative of what the user sees, hears, feels, or otherwise senses. To detect these types of environmental factors, detecting facility 570 may be configured to process visual, audio, and other sensory input data as acquired by I/O facility 540.

For example, detecting facility 570 may be configured to process visual data representative of what the user may see. Such visual data may be acquired by a video camera and/or a still shot camera that may be included within I/O facility 540 and/or otherwise associated with access subsystem 120. Additionally or alternatively, detecting facility 570 may be configured to acquire visual data by analyzing video and/or images that the user views using access subsystem 120.

Additionally or alternatively, detecting facility 570 may be configured to process audio data representative of what the user may hear. Such audio data may be acquired by a microphone or other acoustic sensor that may be included within I/O facility 540 and/or otherwise associated with access subsystem 120. Additionally or alternatively, detecting facility 570 may be configured to acquire audio data by analyzing speech, music, and/or other audio content that the user accesses with access subsystem 120. Other types of sensors may be provided to acquire other types of sensory input data as may serve a particular application.

Additionally or alternatively, detecting facility 570 may be configured to process data representative of what the user may feel (e.g., the mood of the user). Such data may be acquired by one or more sensors that may be included within I/O facility 540 and/or otherwise associated with access subsystem 120. The data may additionally or alternatively be acquired by processing a schedule activities performed by the user.

In some examples, an environmental factor may include anything related to a virtual environment of the user. As used herein, a virtual environment may refer to a user's virtual surroundings such as, but not limited to, content contained within the user's social networks, one or more user profiles corresponding to one or more users, traits or actions of other users within the user's social networks, and/or content contained within websites that are favorites of or accessed by the user. Detecting facility 570 may be configured to detect factors related to a virtual environment of a user by being communicatively coupled to the social network subsystem 110, the network 225, and/or one or more network-enabled access devices 220.

An environmental factor may additionally or alternatively include content related to an electronic environment of the user. As used herein, an electronic environment may refer to any electronic content accessed by the user. Exemplary electronic content may include, but is not limited to, any data record or object (e.g., an electronic file) storing or otherwise associated with content, metadata, data representative of text, one or more messages (e.g., SMS messages, electronic mail messages, instant messages, or MMS messages), one or more symbols, one or more graphics, one or more images (e.g., digital photographs and video frames), email contacts, video, audio, multimedia, video games, or any segment, component, or combination of these or other forms of electronic data that may be accessed by a user. Detecting facility 570 may be configured to detect an environmental factor associated with an electronic environment of a user by processing any of such electronic content.

Agent facility 580 may be configured to perform one or more actions in response to a detected environmental factor. Agent facility 580 may additionally be configured to perform the one or more actions in accordance with a predefined set of rules. These rules may be stored as rules data within storage facility 530 and/or within another device or subsystem (e.g., social network subsystem 110) communicatively coupled to access subsystem 120. In some examples, at least a portion of the rules may be defined by a user of access subsystem 120. Additionally or alternatively, at least a portion of the rules may be automatically generated by agent facility 580 and/or any other facility as may serve a particular application. In some examples, the rules are user-profile specific.

To perform certain actions, as will be described in more detail below, agent facility 580 may be configured to read data from and write data to an electronic address book, contact list, calendar program, and/or other organizational program corresponding to a user. Agent facility 580 may additionally or alternatively have access to financial information, physical location data, and/or any other data associated with the user.

Agent facility 580 may include hardware, computer-readable instructions embodied on a computer-readable medium such as storage facility 530 (e.g., one or more software applications), or a combination of hardware and computer-readable instructions. In certain embodiments, agent facility 580 may be implemented as a software application embodied on a computer-readable medium such as storage facility 530 and configured to direct the processing facility 520 of the access subsystem 120 to execute one or more operations described herein. Exemplary actions that may be performed by agent facility 580 will be described in more detail below.

Virtual entity facility 590 may be configured to generate a “virtual entity” 595 configured to electronically or virtually represent one or more traits. The traits represented by a virtual entity 595 may include any personality trait, habit, tendency, action, like, dislike, preference, and/or other factor associated with a user 230 of the access subsystem 120. Hence, in some examples, a virtual entity 595 may be configured to electronically resemble, emulate, or represent a user 230. Alternatively, a user 230 may define the virtual entity 595 to electronically resemble, emulate, or represent another user 230. In yet another alternative embodiment, the virtual entity 595 may be defined to resemble, emulate, or represent a conjectured person, animal, creature, companion, or other entity having certain traits that the user 230 so desires. As will be described in more detail below, a virtual entity 595 associated with a user 230 may evolve in response to detected environmental factors.

A user's virtual entity 595 may be configured to electronically interact with the user and/or one or more other users 230. Examples of such electronic interaction will be given below. In some examples, the other users 230 with whom the virtual entity facility 590 interacts may be a part of one of the user's social networks. Additionally or alternatively, the other users 230 may have some type of access to content associated with the user via network 225.

In some examples, virtual entity facility 590 may be configured to adjust, update, and/or modify a user's virtual entity 595 in response to one or more environmental factors as detected by detecting facility 570. Such adjustment of the virtual entity 595 may be configured to adjust the manner in which the virtual entity 595 electronically interacts with the user 230 and/or one or more other users 230.

In some examples, virtual entity facility 590 may be configured to adjust, update, and/or modify one or more parameters defining a user's virtual entity 595 in response to one or more environmental factors as detected by detecting facility 570. Such adjustment of the virtual entity 595 may be configured to adjust the manner in which the virtual entity 595 electronically interacts with the user 230 and/or one or more other users 230.

Virtual entity facility 590 may include hardware, computer-readable instructions embodied on a computer-readable medium such as storage facility 530 (e.g., one or more software applications), or a combination of hardware and computer-readable instructions. In certain embodiments, virtual entity facility 590 may be implemented as a software application embodied on a computer-readable medium such as storage facility 530 and configured to direct the processing facility 520 of the access subsystem 120 to execute one or more operations described herein. A virtual entity 595 generated by virtual entity facility 590 may be embodied as a graphical object (e.g., an avatar), speech, text, and/or any other suitable medium or interface as may serve a particular application. Exemplary embodiments of virtual entity 595 and exemplary actions that may be performed by virtual entity 595 will be described in more detail below.

While the agent and virtual entity facilities 580 and 590 have been shown to be included within access subsystem 120, it will be recognized that they may be additionally or alternatively included within social network subsystem 110. Such network resident facilities may be advantageous in certain situations. However, for illustrative purposes, it will be assumed in the examples given herein that the agent and virtual entity facilities 580 and 590 are included within access subsystem 120.

Various features, embodiments, and applications of the agent facility 580 and the virtual entity facility 590 will now be described. It will be recognized that the features, embodiments, and applications described herein are merely illustrative, and that the agent facility 580 and/or virtual entity facility 590 may be configured to perform additional or alternative functions as may serve a particular application.

As mentioned, agent facility 580 may be configured to perform one or more actions in response to a detected environmental factor and in accordance with one or more rules. For example, an agent facility 580 resident within an access device 220 may be configured to communicate with other agent facilities 580 that may be resident within other access devices 220 in response to one or more detected environmental factors and in accordance with one or more rules.

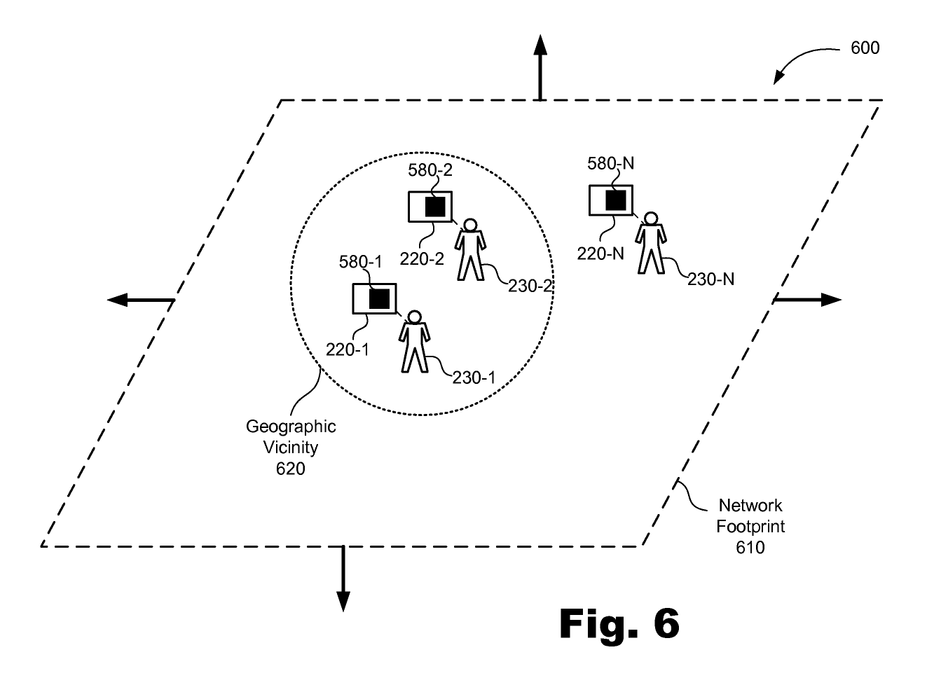

To help facilitate an understanding of an agent facility 580 communicating with at least one other agent facility 580 in response to one or more detected environmental factors, FIG. 6 shows a configuration 600 wherein access devices 220-1, 220-2, and 220-N (collectively referred to as “access devices 220”) are physically located at different geographic locations within an exemplary network footprint 610. The network footprint 610 refers to a collective geographic space within which access devices 220 are able to receive and transmit network communication signals (e.g., signals to or from a satellite or a broadcast tower). As represented by arrows in FIG. 6, the reach of the network footprint 610 may extend beyond the illustrated portion of the network footprint 610. Additionally, while FIG. 6 illustrates a two-dimensional network footprint 610, it will be understood that the network footprint 610 may be three dimensional in certain implementations.

In some examples, one or more of the access devices 220 shown in FIG. 6 may be mobile devices, such as mobile phones. Hence, the access devices 220 may be capable of being carried or otherwise transported from location to location.

One or more of the access devices 220 shown in FIG. 6 may include an agent facility (e.g., agent facilities 580-1 through 580-N, collectively referred to herein as agent facilities 580). In some examples, an agent facility 580 associated with a particular access device 220 may be configured to communicate with one or more other agent facilities 580 in response to a detected environmental factor such as a geographic location of the access device 220.

To illustrate, agent facility 580-1 associated with access device 220-1 may be configured to communicate with other agent facilities 580 residing on other access devices 220 when access device 220-1 is within the same geographic vicinity 620 as the other access devices 220. The boundaries of the geographic vicinity 620 may be user-definable and may include any suitable area as may serve a particular application. For example, the geographic vicinity 620 may include a circle having a radius to be a predetermined distance from the access device 220. Additionally or alternatively, the geographic vicinity 620 may include a particular premises location (e.g., a shopping mall, restaurant, store, meeting place, building, city, etc.). Other boundaries for geographic vicinity 620 may be defined as may serve a particular application.

In the example of FIG. 6, access devices 220-1 and 220-2 are shown to be located within geographic vicinity 620. However, access device 220-N is shown to be located outside of geographic vicinity 620. Hence, agent facility 580-1 may be configured to communicate with agent facility 580-2, but not with agent facility 580-N.

To this end, access device 220-1 may be configured to detect when another access device (e.g., access device 220-2) enters into or is otherwise located within geographic vicinity 620. Such detection may be facilitated by GPS or other location detection technologies.

Communication between access devices 220-1 and 220-2 located within the same geographic vicinity 620 may be in accordance with any predefined rules as may serve a particular application. A number of exemplary communications between access devices 220 located within the same geographic vicinity 620 and rules that govern these communications will now be described in more detail. It will be recognized that the exemplary communications described herein are merely illustrative, and that the access devices 220 within the same geographic vicinity 620 may be configured to perform additional or alternative communications as may serve a particular application.

In some examples, user 230-1 may configure agent facility 580-1 to identify one or more other agent facilities 580 located within geographic vicinity 620 and corresponding to users who match certain criteria. For example, user 230-1 may be a single man desiring to meet a woman to date. To this end, user 230-1 may define a number of rules specifying various criteria that he is looking for in a woman. For example, user 230-1 may specify that he would like to meet a woman with certain physical characteristics, educational background, religious preference, and/or work experience.

With such rules defined, agent facility 580-1 may be configured to communicate with other agent facilities 580 corresponding to access devices 220 that are located within the same geographic vicinity 620 as user 230-1. Because access device 220-1 may be mobile, user 230-1 may take agent facility 580-1 with him as he moves from location to location. In this manner, agent facility 580-1 may constantly search for other agent facilities 580 corresponding to women that match the specified criteria as the user 230-1 moves from location to location.

When agent facility 580-1 detects the presence of another agent facility (e.g., agent facility 580-2) within the same geographic vicinity 620, agent facility 580-1 may be configured to communicate with agent facility 580-2 to determine whether user 230-2 matches the criteria defined by user 230-1. Such communication(s) may include transmission of any suitable data between access devices 220-1 and 220-2 via network 225.

If user 230-2 does not match the predefined criteria, agent facility 580-1 may take no further action. However, if user 230-2 does match the predefined criteria, agent facility 580-1 may be configured to perform one or more predefined actions. For example, agent facility 580-1 may be configured to coordinate with agent facility 580-2 to arrange a meeting between user 230-1 and user 230-2, send an email, text message, or other communication to access device 220-2, create a social networking connection between user 230-1 and user 230-2, alert user 230-1 and/or user 230-2 of the potential match via an audible and/or visible indicator, and/or store contact information corresponding to user 230-2.

In some examples, agent facility 580-1 may be configured to create a log of the potential match for access by the user 230-1 at a later time. For example, the user 230-1 may currently be in a relationship and not interested in dating other people. However, agent facility 580-1 may maintain a log of all potential matches that it detects, and the user 230-1 may access these potential matches when he breaks up and becomes interested in dating other people again.

In some examples, agent facility 580-1 may be configured to communicate with agent facility 580-2 to locate potential matches with one or more users 230 that are in some way associated with user 230-2. These users 230 may be linked to user 230-2 via one or more social networking connections, located within an address book or contact list maintained by user 230-2, and/or otherwise associated with user 230-2. To illustrate, agent facility 580-1 may determine that user 230-2 does not match the criteria defined by user 230-1. However, a friend of user 230-2 may match the criteria defined by user 230-1. In this instance, agent facility 580-1 may identify the match and notify the user 230-1, send a communication to an access device 220 associated with the potential match, and/or perform any other suitable predefined action.

Another example of how an agent facility 580 may be configured to locate one or more users 230 who match certain criteria is in the context of a business conference. Referring to FIG. 6, user 230-1 may represent a business person attending a business conference. Geographic vicinity 620 may represent the conference center, building, or other geographic area or premises hosting the business conference. In some examples, user 230-1 may desire to meet other attendees of the business conference who meet certain criteria. For example, user 230-1 may desire to network with attendees having certain backgrounds, technical skills, business connections, and/or other attributes. To this end, user 230-1 may define a number of rules specifying the types of people that he would like to meet and how he would like to meet them (e.g., in person, via email, via a phone call, etc.).

With such rules defined, agent facility 580-1 may be configured to communicate with other agent facilities 580 corresponding to other users 230 who are also attending the business conference. If agent facility 580-1 identifies a user (e.g., user 230-2) as matching the predefined criteria, agent facility 580-1 may be configured to coordinate with agent facility 580-2 to arrange a meeting between user 230-1 and user 230-2, send an email, text message, or other communication to access device 220-2, create a social networking connection between user 230-1 and user 230-2, alert user 230-1 and/or user 230-2 of the potential match via an audible and/or visible indicator, and/or store contact information corresponding to user 230-2.

In some examples, agent facility 580 may be configured work in conjunction with detecting facility 570 to detect an environmental factor indicative of a repetitive behavior of a user 230 and perform one or more actions in accordance with the detected behavior. For example, an agent facility 580 corresponding to a user 230 may use detected geographic location information, time stamp information, credit card transaction information, detected visual and/or audio information, and/or any other detected environmental factor to detect that the user 230 generally stops at a donut shop every morning on the way to work to buy a donut and juice for breakfast. After the repetitive behavior has been identified, the agent facility 580 may be configured to perform a predefined action in accordance with the repetitive behavior. For example, the agent facility 580 may be configured to electronically place an order with the donut shop once the user 230 is within a predefined distance from the donut shop. In this manner, a donut and juice may be ready for the user 230 to pick up when the user 230 arrives at the donut shop. Other predefined actions may be performed as may serve a particular application.

In some examples, agent facility 580 may be configured to provide a user 230 with a list of options based on the detected repetitive behavior. For example, agent facility 580 may detect that a user 230 generally goes to the movies every Friday night. Once this repetitive behavior has been identified, the agent facility 580 may be configured to provide the user with a list of recommended movies that the user 230 may desire to see. The contents of this list may be based on other movies that the user 230 has seen and/or on specific criteria as defined by the user 230.

In some examples, agent facility 580 may be configured to automatically transmit data representative of a mood of a user 230 to an agent facility 580 corresponding to another user 230. In this manner, the agent facilities 580 may be configured to modify their communication with one another in accordance with the mood of the user 230.

It will be recognized that in the examples described herein, the user 230 may override any action performed by the agent facility 580. It will also be recognized that the actions performed by the agent facility 580 may further be limited by predefined permissions and capabilities of other agent facilities and/or electronic devices. For example, the user 230 may be able to override a financial transaction (e.g., the purchase of a donut), block another agent facility 580 from accessing information stored within the user's access device 220, and/or otherwise control the actions performed by agent facility 580.

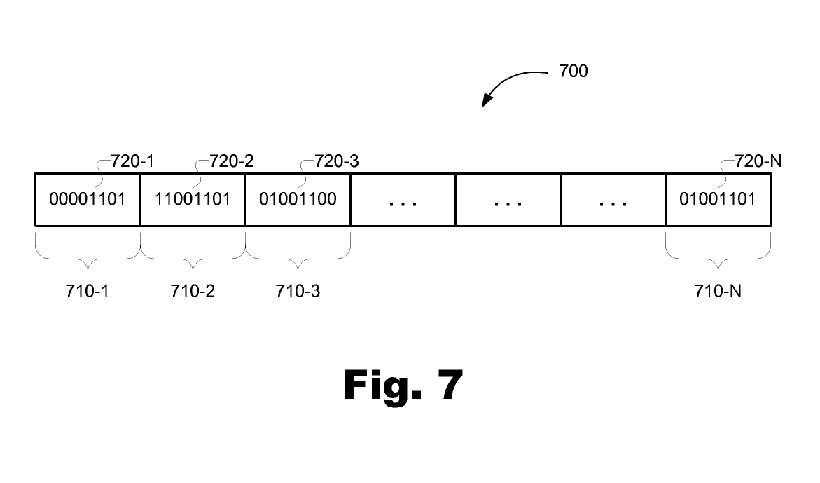

Various features, embodiments, and applications of the virtual entity facility 590 will now be described. As mentioned, virtual entity facility 590 may be configured to generate a virtual entity 595 configured to represent one or more traits. FIG. 7 illustrates an exemplary data structure 700 configured to define a virtual entity 595. As shown in FIG. 7, the data structure 700 may include a number of parameters (e.g., parameters 710-1 through 710-N, collectively referred to herein as “parameters 710”). Each parameter 710 may correspond to a particular trait and may include a bit word (e.g., bit words 720-1 through 720-N, collectively referred to herein as “bit words 720”) configured to represent a particular trait value. The data structure 700 may include any number of parameters 710 configured to represent any number of traits as may serve a particular application. In some examples, the data structure 700, including one or more bit words, may be stored in storage facility 530, data store 430, or any other storage facility as contents of a database (e.g., an SQL database).

Each bit word 720 may include any number of bits as may serve a particular application. For example, the bits words 720 shown in FIG. 7 each include eight bits, thus facilitating 256 possible values for each trait. To illustrate, bit word 720-1 associated with parameter 710-1 may be configured to represent a linguistic accent that the virtual entity 595 uses to communicate with one or more users 230. Because bit word 720-1 includes eight bits, a total of 256 different linguistic accents may be represented by parameter 710-1. As will be described in more detail below, the bit words 720 (and consequently the parameters 710) may be adjusted as the virtual entity 595 “evolves” to represent a change in one or more traits.

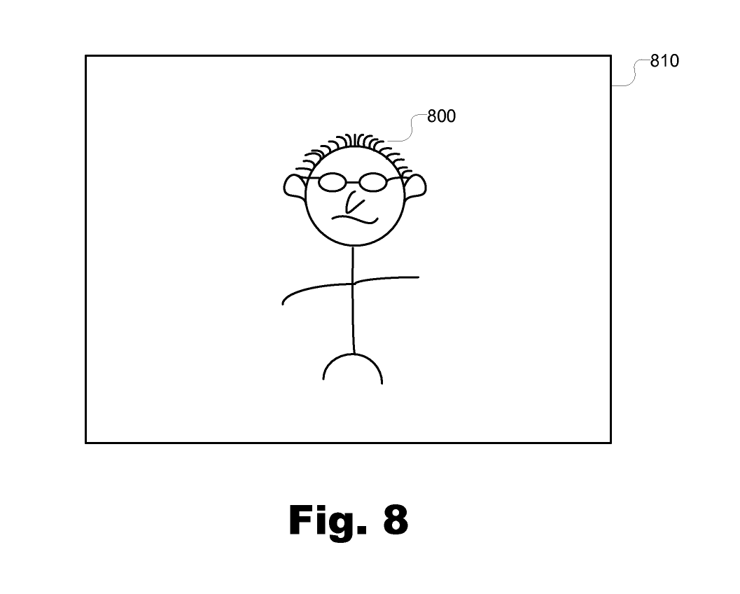

A virtual entity 595 may be represented to the user 230 using any electronic representation as may serve a particular application. For example, a virtual entity 595 may be represented by a graphical object (e.g., an avatar), text, audio, video, and/or any combination thereof. To illustrate, FIG. 8 shows a graphical object 800 configured to represent a virtual entity 595. As shown in FIG. 8, the graphical object 800 may be displayed within an interface 810 (e.g., a graphical user interface) of access subsystem 120. The graphical object 800 may be animated, for example, and interact with one or more users 230 in response to detected environmental factors as will be described in more detail below.

In some examples, access subsystem 120 may be configured to provide a design interface and/or views or content for inclusion in an interface that may be utilized by a user 230 to create a representation of a virtual entity 595. Through the interface, the user 230 may create, update, and otherwise modify how the virtual entity 595 is represented. The design interface may additionally or alternatively be utilized by the user 230 to create, update, or otherwise modify one or more traits represented by the virtual entity 595.

In some alternative examples, access subsystem 120 and/or social network subsystem 110 may be configured to automatically create a representation of the virtual entity 595. For example, access subsystem 120 and/or social network subsystem 110 may be configured to use a random instantiation process or other heuristic to create a representation of the virtual entity 595.

Examples of different types of interaction of a virtual entity 595 with one or more users 230 will now be given. It will be recognized that the examples given herein are merely illustrative, and that additional or alternative examples or implementations of virtual entities may exist as may serve a particular application.

In some examples, a virtual entity 595 associated with a particular user 230 may be configured to play a “companion” role, in which the virtual entity 595 is configured to serve as a virtual companion to the user 230 and interact with the user 230 accordingly. For example, the virtual entity 595 may be configured to engage in conversation with the user 230. The conversation may be visual (e.g., through email, text messages, and/or graphics), audible (e.g., through audible speech), or a combination thereof.

To illustrate, a user 230 may ask the virtual entity 595 questions and the virtual entity 595 may respond to the questions based on detected environmental factors. For example, the user 230 may ask the virtual entity 595 how the weather is before he or she goes outside. Virtual entity facility 590 may utilize a detected environmental factor (e.g., data representative of the weather as detected by detecting facility 570 or retrieved from an external source) to formulate a response that may be delivered to the user 230 by the virtual entity 595.

The manner in which the virtual entity 595 responds to the user 230 may be in accordance with one or more of the traits represented by the virtual entity's data structure 700. For example, various parameters 710 within data structure 700 may be configured to represent a particular accent, mannerism, mood, word choice, animation, or other trait as defined by the user 230. To illustrate, if the user 230 is a teenager, he or she may define the traits such that the virtual entity 595 responds by saying “Dude, it is freaking hot outside” with a southern accent while waving its virtual arms. If the user 230 is a sophisticated adult, he or she may define the traits such that the virtual entity 595 responds by saying “Sir, it currently 98 degrees outside” in a British accent.

A virtual entity 595 may additionally or alternatively provide one or more recommendations to the user 230 while in the “companion” role. To this end, virtual entity facility 590 may be configured to utilize one or more detected environmental factors to generate one or more recommendations that may be provided to the user 230 by the virtual entity 595. For example, virtual entity facility 590 may be configured to analyze electronic content that is accessed by the user 230 or stored by access subsystem 120, visual data representative of what the user 230 sees, audio data representative of what the user 230 hears, and/or any other detected environmental factor and generate one or more recommendations that may be provided by virtual entity 595 to the user 230.

The recommendations provided by virtual entity 595 may include any type of recommendation as may serve a particular application. For example, virtual entity 595 may be configured to recommend specific content instances (e.g., music, video, etc.) to the user 230, suggest activities (e.g., movies, plays, athletic events, etc.) that the user 230 may enjoy based on the detected environmental factors), and/or any other type of recommendation as may serve a particular application.

A virtual entity 595 may additionally or alternatively assist the user 230 in one or more electronic activities or transactions while in the “companion” role. For example, the virtual entity 595 may be configured to assist the user 230 in browsing the Internet by providing suggestions, answers, or other useful information to the user 230. Additionally or alternatively, virtual entity 595 may be configured to assist the user 230 in operating one or more access devices 220. For example, the user 230 may tell the virtual entity 595 that he or she desires to record a particular television show. The virtual entity 595 may be configured to direct a set-top box or the like to record the television show, thus providing a user 230 who may be technically inept with the ability to record a television show without knowing how to program the set-top box directly.

In some examples, a virtual entity 595 associated with a particular user 230 may be configured to play an “assistant” role, in which the virtual entity 595 is configured to function as a virtual assistant and interact with other people (e.g., other users 230 associated with social networking subsystem 110) and/or with other virtual entities 595. For example, the virtual entity 595 may be configured to interact with other users 230 and/or other virtual entities 595 within a social networking context, an online gaming context, and/or any other physical or virtual context as may serve a particular application.

To illustrate, a virtual entity 595 configured to represent a particular user (e.g., user 230-1) may be configured to interact with other users 230 by communicating with those users 230 via email, text messages, graphics, audible speech, and/or any other communication medium. The virtual entity 595 may be configured to communicate with the other users 230 in a manner consistent with one or more traits defined by user 230-1.

As mentioned, a virtual entity 595 may be configured to evolve in response to one or more detected environmental factors. In other words, one or more of the parameters 710 defining a virtual entity 595 may be adjusted in response to one or more detected environmental factors in order to adjust one or more corresponding traits of the virtual entity 595. In this manner, the manner in which the virtual entity 595 interacts with one or more users 230 may be adjusted.

Evolution of a virtual entity 595 may be performed in accordance with one or more rules. For example, adjustment of one or more parameters 710 defining the virtual entity 595 may be performed over a period of time, in response to user experiences, manual changes made by the user 230, and/or any other input as may serve a particular application.

In some examples, evolution of a virtual entity 595 may be implemented using an electronic “mutation” process configured to randomly adjust one or more parameters 710 defining the virtual entity 595. In this manner, a virtual entity 595 corresponding to a user 230 may be configured to randomly evolve as would a living entity. To illustrate, a voice, mood, appearance, and/or other trait of a virtual entity 595 may be configured to randomly change over time.

Additionally or alternatively, evolution of a virtual entity 595 may be implemented using predefined heuristics. For example, a predefined relationship between various environmental factors and specific adjustments to one or more parameters 710 defining the virtual entity 595 may be provided. When one of those environmental factors is detected, virtual entity facility 590 may be configured to adjust one or more parameters 710 defining the virtual entity 595 in accordance with the predefined relationship. To illustrate, virtual entity facility 590 may be configured to adjust an appearance of a virtual entity 595 in response to a detected weather condition.

In some examples, access subsystem 120 may be configured to provide an interface configured to allow a user 230 to adjust one or more parameters 710 defining the virtual entity 595. The interface may additionally or alternatively be configured to allow a user 230 to specify how specific detected environmental factors should be weighted for determining evolution of the virtual entity 595. For example, the virtual entity 595 may be made more sensitive to music, less sensitive to speech, and not sensitive at all to visual input.

In some examples, evolution of a virtual entity 595 may make interaction with the virtual entity 595 more interesting or enjoyable for users 230. Additionally or alternatively, evolution of a virtual entity 595 may make the virtual entity 595 more accurate, personal, and/or useful to one or more users 230.

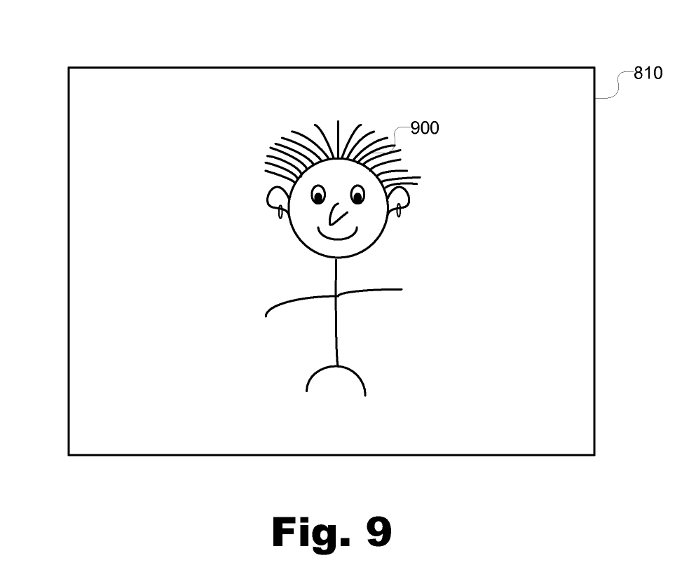

An example of evolution of a virtual entity 595 will now be given in connection with FIG. 9. It will be recognized that the example is merely illustrative, and that a virtual entity 595 may be configured to evolve in additional or alternative manners as may serve a particular application.

FIG. 9 shows a graphical object 900 configured to represent a virtual entity 595 associated with a user 230 that has evolved from the virtual entity 595 represented by graphical object 800 shown in FIG. 8. As shown in FIG. 9, various features of graphical object 900 have changed in comparison to graphical object 800. For example, graphical object 900 has longer hair than graphical object 800 and earrings. Graphical object 900 also does not have the eyeglasses shown in graphical object 800.

The evolution of virtual entity 595, as depicted by the difference in appearance between graphical object 900 and graphical object 800, may be performed in response to one or more detected environmental factors. For example, virtual entity facility 590 may process changes in various virtual environmental factors associated with the user 230 (e.g., changes in traits or actions of one or more friends of user 230), geographic environmental factors (e.g., the user 230 may have moved to a different geographic location), electronic environmental factors (e.g., changes in content accessed by user 230), and/or sensory environmental factors (e.g., changes in what the user 230 senses or experiences). Virtual entity 590 may adjust one or more of the parameters 710 associated with the user's virtual entity 595 in response to these changes in environmental factors.

In some examples, a virtual entity 595 generated by virtual entity facility 590 may be configured to personalize one or more actions performed by agent facility 580. For example, a virtual entity 595 may personalize how an agent facility 580 communicates with other agent facilities 580.

To illustrate, reference is made to the previously discussed example of user 230-1 utilizing agent facility 580-1 to locate a woman matching specified dating criteria. When agent facility 580-1 locates a user (e.g., user 230-2) that matches the specified criteria, agent facility 580-1 may communicate with the user's agent facility 580-2 in a personalized manner as specified by virtual entity 585. For example, agent facility 580-1 may send an MMS message to agent facility 580-2 that includes a graphical object, such as graphical object 800 or 900, saying “Hey, we should go out sometime” in a particular accent, voice, or tone. The graphical object may alternatively deliver any other phrase and in any other manner as defined by virtual entity 595.

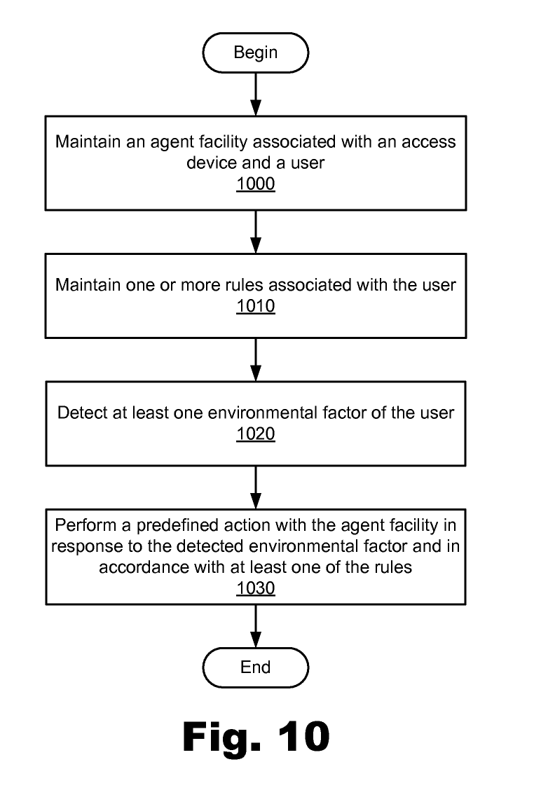

FIG. 10 illustrates an exemplary method of utilizing a agent facility to perform one or more actions. While FIG. 10 illustrates exemplary steps according to one embodiment, other embodiments may omit, add to, reorder, and/or modify any of the steps shown in FIG. 10.

In step 1000, an agent facility associated with an access device and a user is maintained. The agent facility may be similar to agent facility 580, for example, and may be maintained in any of the ways described herein.

In step 1010, one or more rules associated with the user are maintained. The one or more rules may be maintained in any of the ways described herein, including storing data representative of the one or more rules within storage facility 530, data store 430, and/or any other storage medium as may serve a particular application.

In step 1020, at least one environmental factor of the user is detected. The environmental factor may include at least one of a geographic environmental factor, a virtual environmental factor, an electronic environmental factor, and a sensory environmental factor as described herein.

In step 1030, a predefined action is performed with the agent facility in response to the detected environmental factor and in accordance with at least one of the rules. The predefined action may include any of the actions described herein.

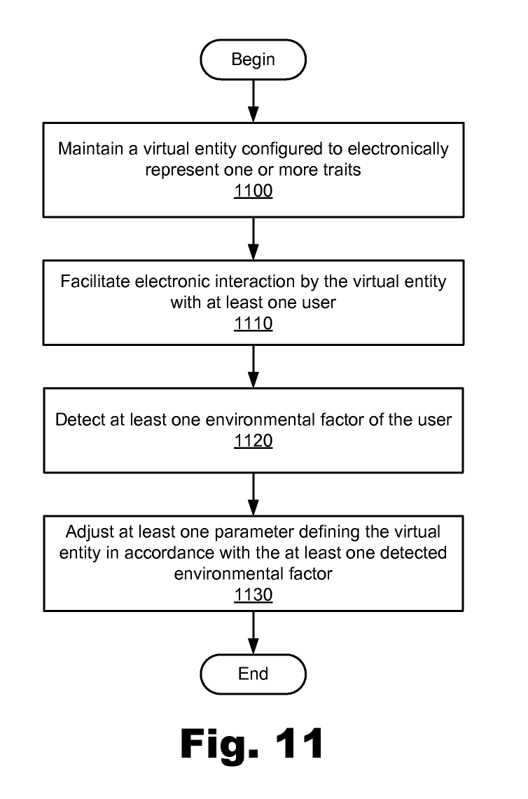

FIG. 11 illustrates an exemplary method of utilizing a virtual entity to interact with at least one user. While FIG. 11 illustrates exemplary steps according to one embodiment, other embodiments may omit, add to, reorder, and/or modify any of the steps shown in FIG. 11.

In step 1100, a virtual entity corresponding to a user and defined by a plurality of parameters is maintained. The virtual entity may be configured to electronically represent one or more traits, and may be maintained and/or generated by virtual entity facility 590, for example.

In step 1110, electronic interaction by the virtual entity with at least one user is facilitated. The at least one user may include a user of an access device corresponding to the virtual entity and/or another user as may serve a particular application. The electronic interaction may be facilitated in any of the ways described herein.

In step 1120, at least one environmental factor of the user is detected. The environmental factor may include at least one of a geographic environmental factor, a virtual environmental factor, an electronic environmental factor, and a sensory environmental factor as described herein.

In step 1130, at least one of the parameters defining the virtual entity is adjusted in accordance with the at least one detected environmental factor. The parameter adjustment is configured to adjust a manner in which the virtual entity electronically interacts with the at least one user.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
maintaining an agent facility associated with an access device and a user;
maintaining data representative of one or more rules associated with said user;
detecting at least one environmental factor of said user; and
performing a predefined action with said agent facility in response to said detected environmental factor and in accordance with at least one of said rules.

2. The method of claim 1, wherein said predefined action comprises communicating with another agent facility associated with another access device and another user.

3. The method of claim 2, further comprising determining, based on said communicating, whether said another user matches criteria defined within said rules by said user.

4. The method of claim 3, further comprising performing another predefined action if said another user matches said criteria, wherein said another predefined action comprises at least one of coordinating a meeting between said user and said another user, transmitting a message to said another access device, alerting said user, and storing contact information corresponding to said another user.

5. The method of claim 1, wherein said environmental factor is indicative of a repetitive behavior of said user, and wherein said predefined action is related to said repetitive behavior.

6. The method of claim 1, wherein said environmental factor comprises at least one of a geographic environmental factor, a virtual environmental factor, an electronic environmental factor, and a sensory environmental factor.

7. The method of claim 1, tangibly embodied as computer-executable instructions on at least one computer-readable medium.

8. A method comprising:
maintaining a virtual entity configured to electronically represent one or more traits, said virtual entity corresponding to a user and defined by a plurality of parameters;
facilitating electronic interaction by said virtual entity with at least one of said user and another user;
detecting at least one environmental factor of said user; and
adjusting at least one of said parameters in accordance with said at least one detected environmental factor;
wherein said adjustment of said at least one of said parameters is configured to adjust a manner in which said virtual entity electronically interacts with said at least one of said user and said another user.

9. The method of claim 8, wherein said virtual entity is configured to function as a virtual companion to said user.

10. The method of claim 8, wherein said virtual entity is configured to function as a virtual assistant to said user.

11. The method of claim 8, wherein said adjusting of said at least one of said parameters comprises randomly adjusting said at least one of said parameters.

12. The method of claim 8, wherein said adjusting of said at least one of said parameters comprises adjusting said at least one of said parameters in accordance with a predefined relationship between said at least one of said parameters and said detected environmental factor.

13. The method of claim 8, wherein said one or more traits are configured to represent at least one of a personality trait, habit, tendency, action, like, dislike, and preference associated with said user.

14. The method of claim 8, further comprising representing said virtual entity to said at least one of said user and said another user via at least one of a graphical object, text, audio, and video.

15. The method of claim 8, wherein said environmental factor comprises at least one of a geographic environmental factor, a virtual environmental factor, an electronic environmental factor, and a sensory environmental factor.

16. The method of claim 8, tangibly embodied as computer-executable instructions on at least one computer-readable medium.

17. A method comprising:
maintaining an agent facility associated with an access device and a user;
maintaining a virtual entity configured to electronically represent one or more traits, said virtual entity corresponding to said user and defined by a plurality of parameters;
maintaining data representative of one or more rules associated with said user;
detecting at least one environmental factor of said user;
performing a predefined action with said agent facility in response to said detected environmental factor and in accordance with at least one of said rules; and
personalizing a manner in which said agent facility performs said predefined action in accordance with said virtual entity.

18. The method of claim 17, wherein said predefined action comprises communicating with another agent facility associated with another access device and another user.

19. The method of claim 17, wherein said environmental factor is indicative of a repetitive behavior of said user, and wherein said predefined action is related to said repetitive behavior.

20. The method of claim 17, further comprising:
adjusting at least one of said parameters in accordance with said at least one detected environmental factor; and
adjusting said personalization of said manner in which said agent facility performs said predefined action.

21. The method of claim 17, wherein said environmental factor comprises at least one of a geographic environmental factor, a virtual environmental factor, an electronic environmental factor, and a sensory environmental factor.

22. A system comprising:
a detecting facility configured to detect at least one environmental factor of a user;
a storage facility configured to maintain data representative of one or more rules; and
an agent facility configured to communicate with another agent facility associated with an access device in response to said detected environmental factor and in accordance with at least one of said rules.

23. The system of claim 22, wherein said communication is configured to determine whether another user associated with said another agent facility matches criteria defined within said rules by said user.

24. A system comprising:
a virtual entity facility configured to generate a virtual entity configured to electronically represent one or more traits, said virtual entity corresponding to a user and defined by a plurality of parameters;
a processing facility configured to facilitate electronic interaction by said virtual entity with at least one of said user and another user; and
a detecting facility configured to detect at least one environmental factor of said user;
wherein said virtual entity facility is further configured to adjust at least one of said parameters in accordance with said at least one detected environmental factor; and
wherein said adjustment of said at least one of said parameters is configured to adjust a manner in which said virtual entity electronically interacts with said at least one of said user and said another user.
